(19) United States
(12) Patent Application Publication
(10) Pub. No.: US 2013/0196293 A1
(43) Pub. Date: Aug. 1, 2013

(54) PHONIC LEARNING USING A MOBILE COMPUTING DEVICE HAVING MOTION SENSING CAPABILITIES

(71) Applicant: Michael C. Wood, Ross, CA (US)

(72) Inventor: Michael C. Wood, Ross, CA (US)

(21) Appl. No.: 13/363,016

(22) Filed: Jan. 31, 2012

(51) Int. Cl. G09B 5/00

(52) U.S. Cl. 434/169

(57) ABSTRACT

A method, system, and apparatus for a phonic learning method implementable on a mobile computing device with a motion sensor are disclosed. A processor generates a phonic object. The phonic object comprises a visual portion and an audible portion. The phonic object is an element of an alphabet, and the audible portion is the phoneme associated with the phonic object. The phonic object and at least one interaction object are displayed. A motion sensor generates a signal representative of the movement of the mobile computing device. The signal is converted into movement of either the phonic object or the interaction object on the screen. When the interaction object and the phonic object interact, an audible signal representative of the audible portion of the phoneme is generated.

### TECHNICAL FIELD

The present disclosure pertains to improvements in the arts of computer-implemented learning environments, namely an interactive method for learning using virtual activities on a mobile computing device.

### BACKGROUND

Educational games attempt to teach the user using a video game as a vehicle. Generally, education games are targeted towards young users from the ages of about three years to the mid-teens. Educational games exist in a variety of fields, including math or typing.

Current education games do not take advantage of modern technology found in a large number of mobile computing devices. Many mobile computing devices now come with operating systems, hardware, and software capable of executing instructions of many different programs. Mobile computing devices also commonly contain some type of motion sensing capabilities. Although mobile computing devices continue to advance, there has yet to be a method developed for phonic learning that takes advantage of the technology available in many mobile computing devices.

It would, therefore, be desirable to have a phonic learning education game that takes advantage of the advances in mobile computing devices, allows interactions between users and the devices that are both fun and educational, and assists a user, whether or a child or adult, in learning the relationship between phonic objects (such as words or letters of a predetermined alphabet associated with a predetermined language) and the sounds associated with the phonic objects.

### SUMMARY

A computer-implemented method of phonic learning, a system, and a computer-readable medium therefor are disclosed. The computer is a mobile computing device having a processor, a memory, a visual peripheral output device, an audio peripheral output device, and a motion sensor.

In one embodiment, a computer-implemented method for interactive learning on a mobile computing device is provided. The computer-implemented method comprises generating, by a processor, a phonic object comprising a visual portion and an audible portion. The phonic object is an element of an alphabet. The audible portion is a phoneme associated with the phonic object. The computer-implemented method further comprises displaying, on a visual peripheral output device, the visual portion of the phonic object in a first position; defining, by the processor, at least one interaction object; generating, by a motion sensor, at least one signal representative of a movement of a mobile computing device; receiving, by the processor, the at least one signal from the motion sensor; altering, by the processor, a position on the visual peripheral output device of one of the phonic object and the at least one interaction object. The position is altered in response to the at least one signal generated by the motion sensor. The computer-implemented method further comprises generating an audible signal, by an audio peripheral output device, in response to an interaction between the phonic object and the interaction object. The audible signal is the audible portion of the phonic object.

In another embodiment, an article of manufacture is provided. The article of manufacture comprises a machine-accessible medium having instructions encoded thereon for enabling a processor to perform the operations of the computer-implemented method disclosed herein.

In yet another embodiment, a system further comprises a mobile device. The mobile device comprises a processor, a motion sensor, a memory subsystem, a visual peripheral output device, and an audio peripheral output device. The memory subsystem is encoded with instructions for enabling the mobile device to perform the operations of the computer-implemented method disclosed herein.

### BRIEF DESCRIPTION OF THE FIGURES

FIG. 1 shows a schematic view of an illustrative electronic device.

FIG. 2 shows one embodiment of an input/output subsystem for an electronic device.

FIG. 3 shows one embodiment of a communications interface for an electronic device.

FIG. 4 shows one embodiment of a memory subsystem for an electronic device.

FIG. 5 shows one embodiment of a computer-implementable phonic learning method.

FIG. 6 shows one embodiment of a mobile computing device implementing the phonic learning method.

FIG. 7 shows one embodiment of a computer-implementable phonic learning method.

FIGS. 8-14 are screenshots of one embodiment of the phonic learning method implemented on a mobile computing device.

FIG. 15 shows one embodiment of a computer-implementable phonic learning method.

FIGS. 16-22 are screenshots of a second embodiment of the phonic learning method implemented on a mobile computing device.

FIG. 23 shows one embodiment of a computer-implementable foreign language phonic learning method.

### DESCRIPTION

The present disclosure describes methods, systems, and computer-readable media for phonic learning using a mobile computing device.

It is to be understood that this disclosure is not limited to particular aspects or embodiments described, and as such may vary. It is also to be understood that the terminology used herein is for the purpose of describing particular aspects or embodiments only, and is not intended to be limiting, since the scope of the method and system for phonic learning using mobile computing device is defined only by the appended claims. A general overview of the various embodiments is provided in the description immediately following and particular implementation of the various embodiments is provided with reference to the figures. The overall scope of the present disclosure is provided ion the appended claims.

In one embodiment, generally, the present disclosure provides a computer-implemented method for phonic learning using a mobile computing device comprises generating a phonic object comprising a visual portion and an audible portion. The phonic object is selected from a set of objects that make up an alphabet. The audible portion of the phonic object is a phoneme associated with the phonic object. The method further comprises displaying the visual portion of the phonic object on the screen of a visual peripheral output device. An interaction object is defined by the processor. A motion sensor is used to generate a signal representative of movement or orientation of the mobile computing device. The signal is received by a processor, which converts the signal into movement of either the phonic object or the interaction object. An audible signal is generated in response to an interaction between the phonic object and the interaction object, wherein the audible signal is the audible portion of the phonic object. In one embodiment, at least one static interaction object is generated, wherein the audible signal is generated in response to an interaction between the phonic object and the at least one static interaction object.

In one embodiment, the method comprises generating a word comprising one or more target phonic objects. The phonic object displayed on the screen is selected from the one or more target phonic objects. In one embodiment, a second audible signal is generated by the audio peripheral output device. The second audible signal is representative of the phonic sound of the word. In various embodiments, the second audible signal may be generated prior to display the phonic object on the visual peripheral output device.

In one embodiment, the method comprises displaying at least one correctly identified phonic object on the visual peripheral output device. The at least one correctly identified phonic object is displayed in a position corresponding to the at least one correctly identified phonic object's position in the word. In one embodiment, the second audible signal is generated when all of the one or more target phonic objects have been displayed on the visual peripheral output device.

In one embodiment, the method comprises displaying at least one additional phonic object. In some embodiments, the phonic object and the at least one additional phonic object may be displayed within graphical containers on the visual peripheral output device.

In one embodiment, an article of manufacture comprising a machine-accessible medium having instructions encoded thereon for enabling a processor to perform the operations of the disclosed method for phonic learning. In another embodiment, a system for phonic learning is disclosed. The system comprises a mobile computing device comprising a processor, a motion sensor, a memory system, a visual peripheral output device, and an audio peripheral output device. The memory system of the mobile computing device is encoded with instruction for enabling the mobile device to perform the steps of the disclosed method for phonic learning.

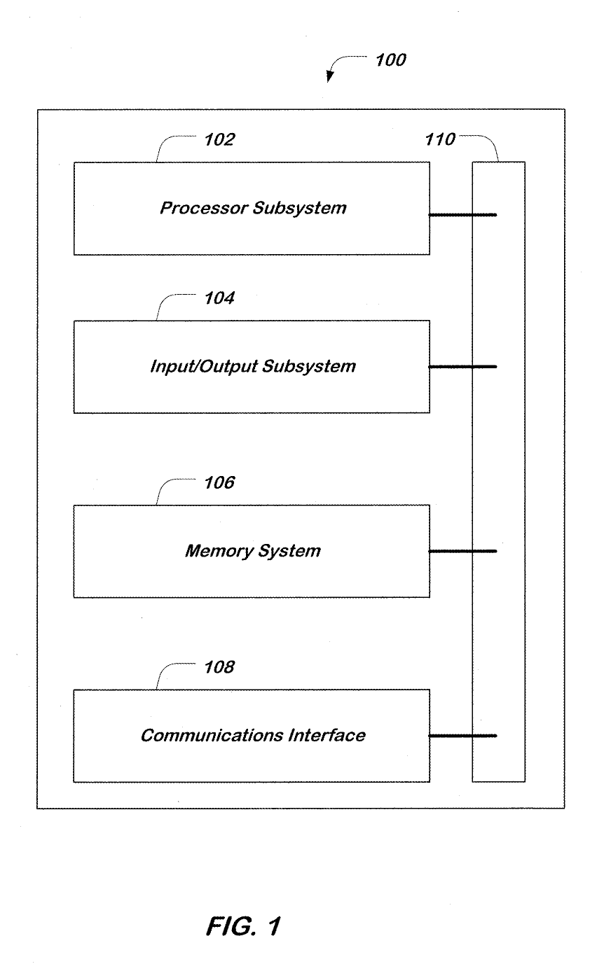

Turning now to the figures, FIG. 1 is a schematic view of an illustrative electronic device 100 capable of implementing the system and method of phonic learning using a mobile computing device. Electronic device 100 may comprise a processor subsystem 102, an input/output subsystem 104, a memory subsystem 106, a communications interface 108, and a system bus 110. In some embodiments, one or more than one of the electronic device 100 components may be combined or omitted such as, for example, not including the communications interface 108. In some embodiments, the electronic device 100 may comprise other components not combined or comprised in those shown in FIG. 1. For example, the electronic device 100 also may comprise a power subsystem. In other embodiments, the electronic device 100 may comprise several instances of the components shown in FIG. 1. For example, the electronic device 100 may comprise multiple memory subsystems 106. For the sake of conciseness and clarity, and not limitation, one of each of the components is shown in FIG. 1.

The processor subsystem 102 may comprise any processing circuitry operative to control the operations and performance of the electronic device 100. In various aspects, the processor subsystem 102 may be implemented as a general purpose processor, a chip multiprocessor (CMP), a dedicated processor, an embedded processor, a digital signal processor (DSP), a network processor, a media processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The processor subsystem 102 also may be implemented by a controller, a microcontroller, an application specific integrated circuit (ASIC), a field programmable gate array (FPGA), a programmable logic device (PLD), and so forth.

In various aspects, the processor subsystem 102 may be arranged to run an operating system (OS) and various mobile applications. Examples of an OS comprise, for example, operating systems generally known under the trade name of Apple OS, Microsoft Windows OS, Android OS, and any other proprietary or open source OS. Examples of mobile applications comprise, for example, a telephone application, a camera (e.g., digital camera, video camera) application, a browser application, a multimedia player application, a gaming application, a messaging application (e.g., email, short message, multimedia), a viewer application, and so forth.

In some embodiments, the electronic device 100 may comprise a system bus 110 that couples various system components including the processing subsystem 102, the input/output subsystem 104, and the memory subsystem 106. The system bus 110 can be any of several types of bus structure(s) including a memory bus or memory controller, a peripheral bus or external bus, and/or a local bus using any variety of available bus architectures including, but not limited to, 9-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect Card International Association Bus (PCMCIA), Small Computers Interface (SCSI) or other proprietary bus, or any custom bus suitable for mobile computing device applications.

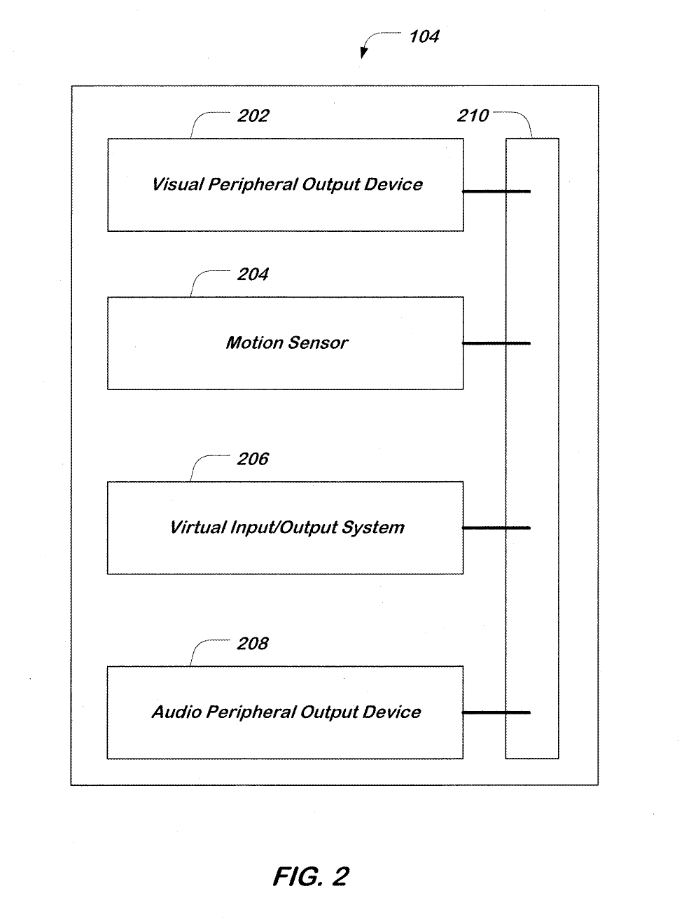

FIG. 2 shows one embodiment of the input/output subsystem 104 of the electronic device 100 shown in FIG. 1. The input/output subsystem 104 may comprise any suitable mechanism or component to at least enable a user to provide input to the electronic device 100 and the electronic device 100 to provide output to the user. For example, the input/output subsystem 104 may comprise any suitable input mechanism, including but not limited to, a button, keypad, keyboard, click wheel, touch screen, or motion sensor. In some embodiments, the input/output subsystem 104 may comprise a capacitive sensing mechanism, or a multi-touch capacitive sensing mechanism. Descriptions of capacitive sensing mechanisms can be found in U.S. Patent Application Publication No. 2006/0026521, entitled “Gestures for Touch Sensitive Input Device” and U.S. Patent Publication No. 2006/0026535, entitled “Mode-Based Graphical User Interfaces for Touch Sensitive Input Device,” both of which are incorporated by reference herein in their entirety. It will be appreciated that any of the input mechanisms described herein may be implemented as physical mechanical components, virtual elements, and/or combinations thereof.

In some embodiments, the input/output subsystem 104 may comprise specialized output circuitry associated with output devices such as, for example, an audio peripheral output device 208. The audio peripheral output device 208 may comprise an audio output including on or more speakers integrated into the electronic device. The speakers may be, for example, mono or stereo speakers. The audio peripheral output device 208 also may comprise an audio component remotely coupled to audio peripheral output device 208 such as, for example, a headset, headphones, and/or ear buds which may be coupled to the audio peripheral output device 208 through the communications subsystem 108.

In some embodiments, the input/output subsystem 104 may comprise a visual peripheral output device 202 for providing a display visible to the user. For example, the visual peripheral output device 202 may comprise a screen such as, for example, a Liquid Crystal Display (LCD) screen, incorporated into the electronic device 100. As another example, the visual peripheral output device 202 may comprise a movable display or projecting system for providing a display of content on a surface remote from the electronic device 100. In some embodiments, the visual peripheral output device 202 can comprise a coder/decoder, also known as a Codec, to convert digital media data into analog signals. For example, the visual peripheral output device 202 may comprise video Codecs, audio Codecs, or any other suitable type of Codec.

The visual peripheral output device 202 also may comprise display drivers, circuitry for driving display drivers, or both. The visual peripheral output device 202 may be operative to display content under the direction of the processor subsystem 102. For example, the visual peripheral output device 202 may be able to play media playback information, application screens for application implemented on the electronic device 100, information regarding ongoing communications operations, information regarding incoming communications requests, or device operation screens, to name only a few.

In some embodiments, the input/output subsystem 104 may comprise a motion sensor 204. The motion sensor 204 may comprise any suitable motion sensor operative to detect movements of electronic device 100. For example, the motion sensor 204 may be operative to detect acceleration or deceleration of the electronic device 100 as manipulated by a user. In some embodiments, the motion sensor 204 may comprise one or more three-axis acceleration motion sensors (e.g., an accelerometer) operative to detect linear acceleration in three directions (i.e., the x or left/right direction, the y or up/down direction, and the z or forward/backward direction). As another example, the motion sensor 204 may comprise one or more two-axis acceleration motion sensors which may be operative to detect linear acceleration only along each of x or left/right and y or up/down directions (or any other pair of directions). In some embodiments, the motion sensor 204 may comprise an electrostatic capacitance (capacitance-coupling) accelerometer that is based on silicon micro-machined MEMS (Micro Electro Mechanical Systems) technology, a piezoelectric type accelerometer, a piezoresistance type accelerometer, or any other suitable accelerometer.

In some embodiments, the motion sensor 204 may be operative to directly detect rotation, rotational movement, angular displacement, tilt, position, orientation, motion along a non-linear (e.g., arcuate) path, or any other non-linear motions. For example, when the motion sensor 204 is a linear motion sensor, additional processing may be used to indirectly detect some or all of the non-linear motions. For example, by comparing the linear output of the motion sensor 204 with a gravity vector (i.e., a static acceleration), the motion sensor 204 may be operative to calculate the tilt of the electronic device 100 with respect to the y-axis. In some embodiments, the motion sensor 204 may instead or in addition comprise one or more gyro-motion sensors or gyroscopes for detecting rotational movement. For example, the motion sensor 204 may comprise a rotating or vibrating element.

In some embodiments, the motion sensor 204 may comprise one or more controllers (not shown) coupled to the accelerometers or gyroscopes. The controllers may be used to calculate a moving vector of the electronic device 100. The moving vector may be determined according to one or more predetermined formulas based on the movement data (e.g., x, y, and z axis moving information) provided by the accelerometers or gyroscopes.

In some embodiments, the input/output subsystem 104 may comprise a virtual input/output system 206. The virtual input/output system 206 is capable of providing input/output options by combining one or more input/output components to create a virtual input type. For example, the virtual input/output system 206 may enable a user to input information through an on-screen keyboard which utilizes the touch screen and mimics the operation of a physical keyboard or using the motion sensor 204 to control a pointer on the screen instead of utilizing the touch screen. As another example, the virtual input/output system 206 may enable alternative methods of input and output to enable use of the device by persons having various disabilities. For example, the virtual input/output system 206 may convert on-screen text to spoken words to enable reading-impaired persons to operate the device.

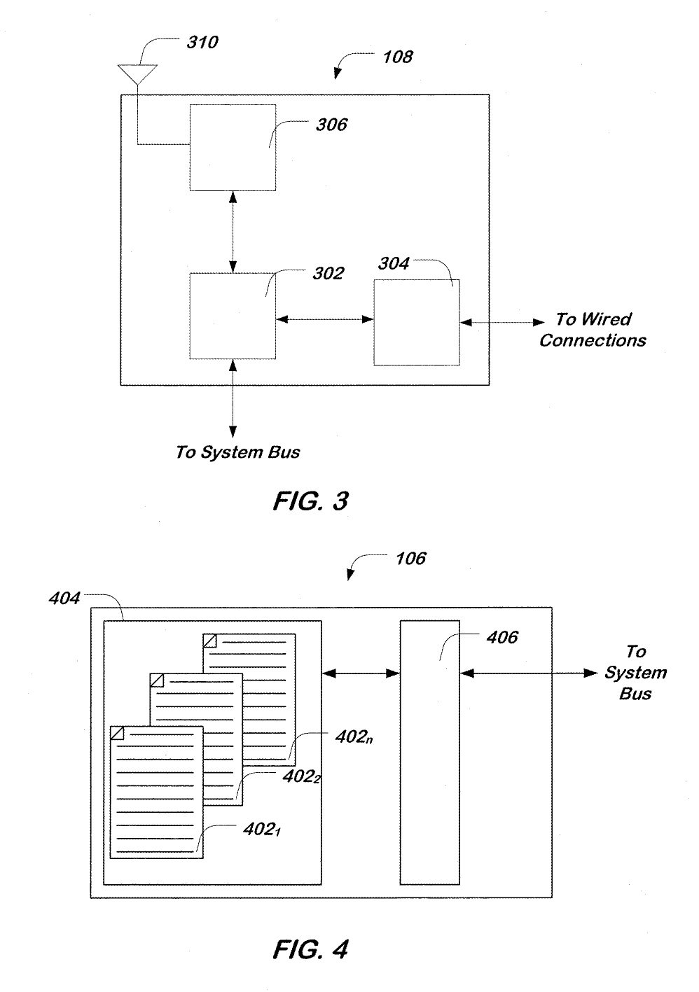

FIG. 3 shows one embodiment of the communication interface 108. The communications interface 108 may comprises any suitable hardware, software, or combination of hardware and software that is capable of coupling the electronic device 100 to one or more networks and/or devices. The communications interface 108 may be arranged to operate with any suitable technique for controlling information signals using a desired set of communications protocols, services or operating procedures. The communications interface 108 may comprise the appropriate physical connectors to connect with a corresponding communications medium, whether wired or wireless.

Vehicles of communication comprise a network. In various aspects, the network may comprise local area networks (LAN) as well as wide area networks (WAN) including without limitation Internet, wired channels, wireless channels, communication devices including telephones, computers, wire, radio, optical or other electromagnetic channels, and combinations thereof, including other devices and/or components capable of/associated with communicating data. For example, the communication environments comprise in-body communications, various devices, and various modes of communications such as wireless communications, wired communications, and combinations of the same.

Wireless communication modes comprise any mode of communication between points (e.g., nodes) that utilize, at least in part, wireless technology including various protocols and combinations of protocols associated with wireless transmission, data, and devices. The points comprise, for example, wireless devices such as wireless headsets, audio and multimedia devices and equipment, such as audio players and multimedia players, telephones, including mobile telephones and cordless telephones, and computers and computer-related devices and components, such as printers.

Wired communication modes comprise any mode of communication between points that utilize wired technology including various protocols and combinations of protocols associated with wired transmission, data, and devices. The points comprise, for example, devices such as audio and multimedia devices and equipment, such as audio players and multimedia players, telephones, including mobile telephones and cordless telephones, and computers and computer-related devices and components, such as printers. In various implementations, the wired communication modules may communicate in accordance with a number of wired protocols. Examples of wired protocols may comprise Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, to name only a few examples.

Accordingly, in various aspects, the communications interface 108 may comprise one or more interfaces such as, for example, a wireless communications interface 306, a wired communications interface 304, a network interface, a transmit interface, a receive interface, a media interface, a system interface, a component interface, a switching interface, a chip interface, a controller, and so forth. When implemented by a wireless device or within wireless system, for example, the communications interface 108 may comprise a wireless interface 306 comprising one or more antennas 310, transmitters, receivers, transceivers, amplifiers, filters, control logic, and so forth.

In various aspects, the communications interface 108 may provide voice and/or data communications functionality in accordance with different types of cellular radiotelephone systems. In various implementations, the described aspects may communicate over wireless shared media in accordance with a number of wireless protocols. Examples of wireless protocols may comprise various wireless local area network (WLAN) protocols, including the Institute of Electrical and Electronics Engineers (IEEE) 802.xx series of protocols, such as IEEE 802.11a/b/g/n, IEEE 802.16, IEEE 802.20, and so forth. Other examples of wireless protocols may comprise various wireless wide area network (WWAN) protocols, such as GSM cellular radiotelephone system protocols with GPRS, CDMA cellular radiotelephone communication systems with 1xRTT, EDGE systems, EV-DO systems, EV-DV systems, HSDPA systems, and so forth. Further examples of wireless protocols may comprise wireless personal area network (PAN) protocols, such as an Infrared protocol, a protocol from the Bluetooth Special Interest Group (SIG) series of protocols, including Bluetooth Specification versions v1.0, v1.1, v1.2, v2.0, v2.0 with Enhanced Data Rate (EDR), as well as one or more Bluetooth Profiles, and so forth. Yet another example of wireless protocols may comprise near-field communication techniques and protocols, such as electro-magnetic induction (EMI) techniques. An example of EMI techniques may comprise passive or active radio-frequency identification (RFID) protocols and devices. Other suitable protocols may comprise Ultra Wide Band (UWB), Digital Office (DO), Digital Home, Trusted Platform Module (TPM), ZigBee, and so forth.

In various implementations, the described aspects may comprise part of a cellular communication system. Examples of cellular communication systems may comprise CDMA cellular radiotelephone communication systems, GSM cellular radiotelephone systems, North American Digital Cellular (NADC) cellular radiotelephone systems, Time Division Multiple Access (TDMA) cellular radiotelephone systems, Extended-TDMA (E-TDMA) cellular radiotelephone systems, Narrowband Advanced Mobile Phone Service (NAMPS) cellular radiotelephone systems, third generation (3G) wireless standards systems such as WCDMA, CDMA-2000, UMTS cellular radiotelephone systems compliant with the Third-Generation Partnership Project (3GPP), fourth generation (4G) wireless standards, and so forth.

FIG. 4 shows one embodiment of the memory subsystem 106. The memory subsystem 106 may comprise any machine-readable or computer-readable media capable of storing data, including both volatile/non-volatile memory and removable/non-removable memory. The memory subsystem 106 may comprise at least one non-volatile memory unit 402. The non-volatile memory unit 402 is capable of storing one or more software programs 404₁-404ₙ. The software programs 404₁-404ₙ may contain, for example, applications, user data, device data, and/or configuration data, or combinations therefore, to name only a few. The software programs 404₁-404ₙ may contain instructions executable by the various components of the electronic device 100.

In various aspects, the memory subsystem 106 may comprise any machine-readable or computer-readable media capable of storing data, including both volatile/non-volatile memory and removable/non-removable memory. For example, memory may comprise read-only memory (ROM), random-access memory (RAM), dynamic RAM (DRAM), Double-Data-Rate DRAM (DDR-RAM), synchronous DRAM (SDRAM), static RAM (SRAM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk memory (e.g., floppy disk, hard drive, optical disk, magnetic disk), or card (e.g., magnetic card, optical card), or any other type of media suitable for storing information.

In some embodiments, the memory subsystem 106 may contain a software program for interactive phonic learning using the capabilities of the mobile computing device 100 and the motion sensor 204, as discussed in connection with FIGS. 1-2. In one embodiment, the memory subsystem 106 may contain an instruction set, in the form of a file 404ₙ for executing a method of phonic learning on the mobile computing device. The instruction set may be stored in any acceptable form of machine readable instructions, including source code or various appropriate programming languages. Some examples of programming languages that may be used to store the instruction set comprise, but are not limited to: Java, C, C++, C#, Python, Objective-C, Visual Basic, or .NET programming. In some embodiments a compiler or interpreter is comprised to convert the instruction set into machine executable code for execution by the processing subsystem 102.

Examples of handheld mobile devices suitable for implementing the system and method of phonic learning using a mobile computing device comprise, but are not limited to: the Apple iPhone™ and iPod™, RIM Blackberry® Curve™, Pearl™, Storm™, and Bold™; Hewlett Packard Veer; Palm® (now HP) Pixi™, Pre™; Google Nexus S™, Motorola DEFY™, Droid (generations 1-3), Droid X, Droid X2, Flipside™, Atrix™, and Citrus™; HTC Incredible™ Inspire™, Surround™, EVO™, G2™, HD7, Sensation™, Thunderbolt™, and Trophy™; LG Fathom™, Optimus T™, Phoenix™, Quantum™, Revolution™, Rumor Touch™, and Vortex™; Nokia Astound™; Samsung Captivate™, Continuum™, Dart™, Droid Charge™, Exhibit™ Epic™, Fascinate™, Focus™, Galaxy S™, Gravity™, Infuse™, Replenish™, Seek™, and Vibrant™, Pantech Crossover; T-Mobile® G2™, Comet™, myTouch™; Sidekick®; Sanyo Zio™; Sony Ericsson Xperia™ Play.

Examples of tablet computing devices suitable for implementing the system and method of phonic learning using a mobile computing device comprise, but are not limited to: Acer Iconia Tab A500, the Apple iPad™ (1 and 2), Asus Eee Pad Transformer, Asus Eee Slate, Coby Kyros, Dell Streak, Hewlett Packard TouchPad, Motorola XOOM, Samsung Galaxy Tab, Archos 101 internet tablet, Archos 9 PC tablet, Blackberry PlayBook, Hewlett Packard Slate, Notion ink Adam, Toshiba Thrive, and the Viewsonic Viewpad.

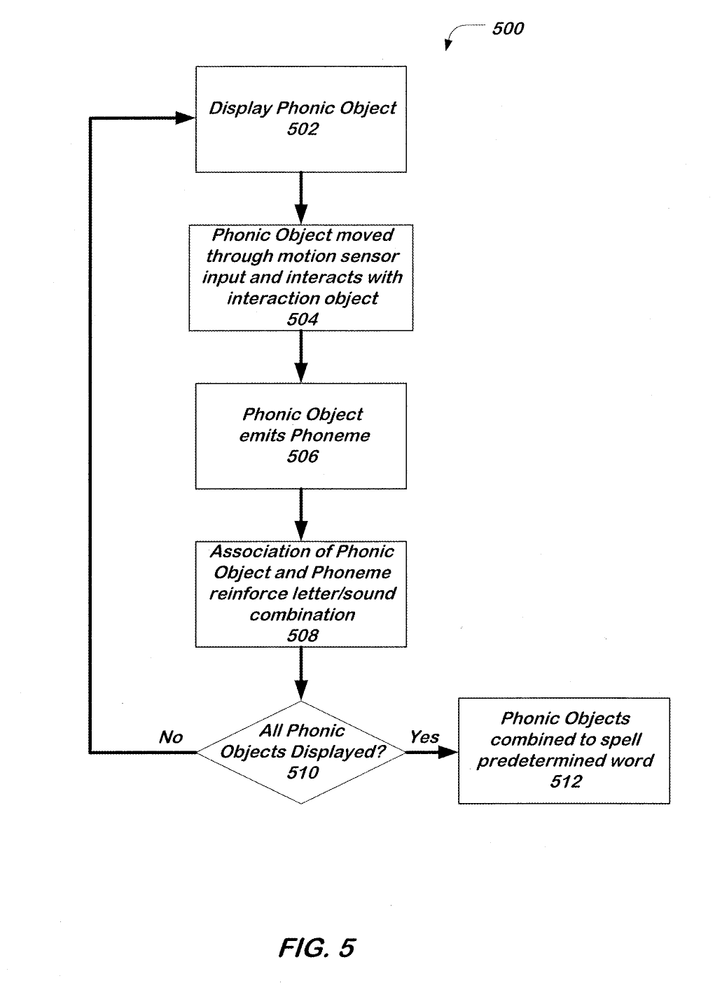

FIG. 5 shows one embodiment of a method for phonic learning 500 using a mobile computing device, such as the electronic device 100 having a motion sensor 204, as discussed in connection with FIGS. 1-4. In one embodiment, the method for phonic learning 500 comprises displaying 502 a phonic object on a visual peripheral output device 202. A phonic object is an object having a visual portion and an audible portion. The audible portion is a sound or phoneme associated with the visual portion. A phoneme is the smallest segmental unit of sound employed to form meaningful contrasts between utterances. An example of a phonic object may be the English variant of the Latin letter “K.” Any letters associated with any predetermined alphabets of any predetermined language may be employed. The visual portion of the phonic object is the symbol “K” which represents a phoneme. The phoneme of the phonic object “K” is the /k/ phoneme. (In transcription, phonemes are designated with slashes.) The /k/phoneme represents the audible portion of the phonic object “K.” In English, this phoneme may have a hard K, or “Ka,” sound or an aspirated K, or “K^{h}a,” sound. Therefore, one example of a phonic object that may be selected by the method for phonic learning 500 is the English variant of the Latin letter “K” with an associated phoneme, /k/, which has a hard K, or “Ka,” sound. Additional examples of phonics and phonemes in the context of educational computer-implemented learning techniques can be found in commonly assigned Patent Application No. PCT/US2010/062441, entitled “Interactive Learning Method, Apparatus, and System,” which is incorporated by reference herein in its entirety.

In some embodiments, the method for phonic learning 500 may choose a phonic object randomly from a predetermined phonic object set. In some embodiments, phonic object sets may comprise, for example, alphabets or abjads (alphabets with consonants only) such as the Latin, Greek, Arabic, Syriac, Cyrillic, or Hebrew alphabet which may be used to generate appropriate phonic objects. In other embodiments, the phonic object set may be a subset of an alphabet, such as, for example, vowels or consonants. Those skilled in the art will recognize that any language using discrete phonic objects may be used in various embodiments.

In the embodiment shown in FIG. 5, the location of the phonic object on the visual peripheral output device 202 may be affected by a user through various inputs, including input from the motion sensor 204. The user can alter the position of the phonic object by tilting or moving the electronic device 100. The motion of the electronic device 100 is converted into an electrical signal by the motion sensor 204 and transmitted to the processor subsystem 102. The processor subsystem 102 interprets the electrical signal, as discussed above, and translates the electrical signal into motion of the phonic object on the display. When the phonic object interacts with an environmental element, such as the edge of the display screen or another object on the visual peripheral output device 202 (referred to as an interaction object), the electronic device 100, through the audio peripheral output device 208, generates an audible signal representative of the phoneme associated with the phonic object. To continue the example from above, when the phonic object displayed to the user is the English variant of the phonic object “K” then each time the phonic object interacts with the edge of the display screen, the electronic device 100 would generate the “Ka” sound of the associated /k/ phoneme.

In one aspect, the method functions as an interactive phonic learning device by associating the appearance of a phonic object on the display and the audible phoneme that is generated by the electronic device 100 each time the phonic object interacts with the environment or an interaction object.

In some embodiments, the phonic objects may be selected such that they spell a word when all of the phonic objects have been displayed. The electronic device 100 may display the identified phonic objects somewhere on the visual peripheral output device 202 to show the user the progress of spelling a word as each phonic object is identified. In one embodiment, the identified phonic objects are displayed at the bottom of the screen. Once all of the phonic objects that comprise the selected word have been displayed, the electronic device 100 may generate an audible signal representative of the pronunciation of the selected word. In some embodiments, this pronunciation may comprise a recitation of each of the phoneme sounds, followed by a recitation of the entire word. In other embodiments, only the sound associated with the selected word may be generated.

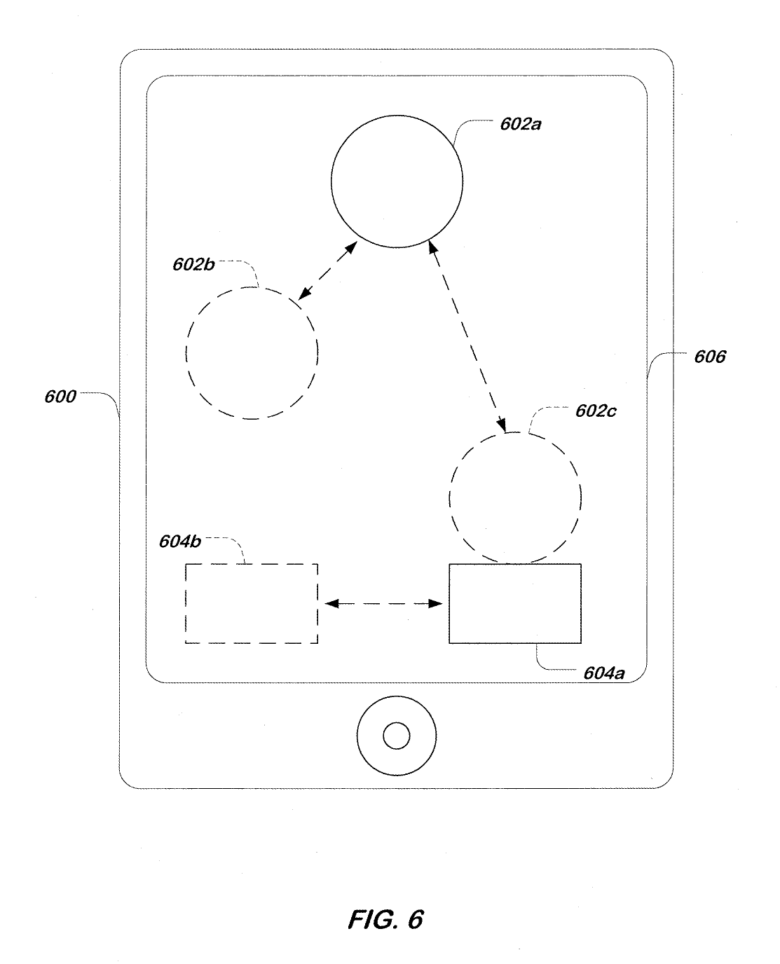

FIG. 6 shows one implementation of the phonic learning method 500 on an electronic device 600. The electronic device 600 is one embodiment of the electronic device 100 shown in and described in connection with FIGS. 1-4. In addition, the electronic device 600 comprises a display screen 606 connected to the visual peripheral output device 202. A phonic object 602a is displayed in a first position. The position of the phonic object 602a may be affected through any suitable input, for example, through the motion sensor 204. As shown by the phantom phonic objects 602b, 602c, the phonic object 602a can be moved on the display screen 606 by manipulating the electronic device 600. For example, in order to move the phonic object 602a from the first position to a second position represented by phantom phonic object 602b, a user may tilt the electronic device 600 to the left, causing the phonic object 602a to move to the left of the display screen 606. A user also may tilt the electronic device 600 along an axis extending perpendicular to the drawing. Tilting the electronic device 600 along the axis perpendicular to the page may impart a downward movement to the phonic object 602a. The combination of these two movements will result in the phonic object 602a moving from the first position to the position illustrated by the phantom phonic object 602b. In some embodiments, the phonic object 602a may be displayed as a phonic object located within a graphical container such as, for example, a bubble. It will be appreciated that the electronic device 600 may be tilted along any suitable axis or combinations thereof to produce any suitable effect as may be desired by the user.

An interaction object 604a may be generated and displayed by the visual peripheral output device 202 on the display screen 606. In some embodiments, the position of the interaction object 604a may be affected by any suitable input such as, for example, the motion sensor 204. As shown by the phantom interaction object 604b, the interaction object can be moved on the display screen 606 by manipulating the electronic device 600. For example, in order to move the interaction object from its original position to a second position represented by phantom interaction object 604b, a user my tilt the electronic device 600 to the left, causing the interaction object 604a to move to the left of the display screen 606. In some embodiments, the interaction object may be an animated graphical character such as, for example, a cartoon ant. In some embodiments, the animated graphical character may be shown performing an activity such as, for example, snowboarding.

As shown in FIG. 6, an interaction between the phonic object 602a and the interaction object 604a may occur. This interaction may occur by causing the phonic object to move into the interaction object, causing the interaction object to move into the phonic object, or both. FIG. 6 shows one embodiment in which the phonic object 602a has been caused to move into virtual contact with the interaction object 604a. When the phonic object 602a reaches the position shown by phantom phonic object 602c, causing the phonic object 602a and the interaction object 604a come into virtual contact, the phonic learning method 500 will generate an audible signal representative of the phoneme of the phonic object. The audible signal also may be generated when the phonic object 602a intersects with the edge of the display screen 606.

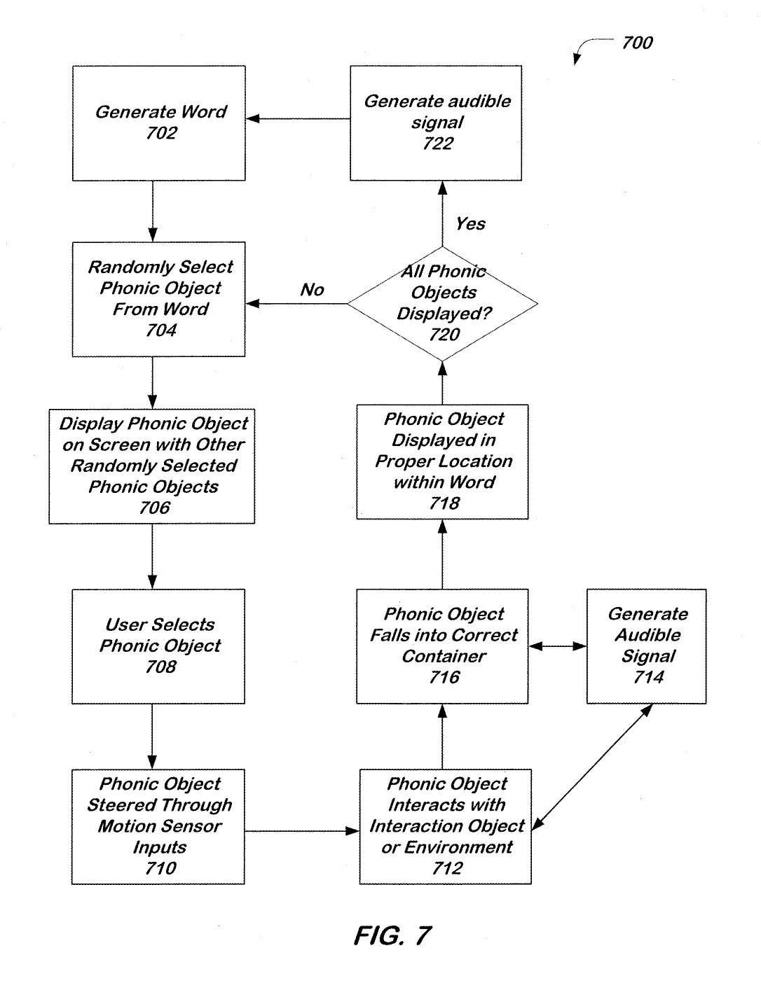

FIG. 7 shows a logic diagram of one embodiment of a phonic learning method 700 which can be implemented by a mobile computing device 100, as discussed in connection with FIGS. 1-4. In one embodiment, a set of computer-executable instructions (e.g., a program) corresponding to the phonic learning method 700 is loaded into the volatile memory of the electronic device 100. The program comprises a computer-executable instruction set for executing the phonic learning method 700. Once loaded, the processor subsystem 102 of the electronic device 100 will execute the stored instruction set. In some embodiments, the program may comprise computer-executable instructions for generating and displaying a background image and several static interaction objects on the visual peripheral output device 202.

In some embodiments, in accordance with the phonic learning method 700, a word associated with a predetermined language is generated 702. The word may be randomly selected from a predefined list of words. In one embodiment, predefined lists of words may be generated comprising varying levels of difficulty such as, for example, grouping words containing fewer phonic objects or that are easily spelled as a lower level list and grouping words containing a large number of phonic objects or difficult spellings as a higher level list. In another embodiment, word lists may be generated by grouping words based on various grammatical or phonetic rules, such as, for example, list containing words with a “ph” or words that utilize the “i before e rule.” Methods, systems, and apparatus for developing a structured curriculum and divided into a plurality of levels can be found in commonly assigned Patent Application No. PCT/US2010/062441, entitled “Interactive Learning Method, Apparatus, and System,” which is incorporated by reference herein in its entirety. It will be appreciated that any grouping system may be used to create a predetermined set of word lists. All such systems and groupings are within the scope of the appended claims.

After generating a word, in accordance with the phonic learning method 700, a phonic object associated with the word may be selected 704. In some embodiments, the phonic objects may be selected in sequential order based on their appearance in the word that has been selected. For example, when the word selected is “CAT,” the first phonic object displayed to the user may be a “C,” the second phonic object an “A,” and the third phonic object a “T.” In other embodiments, the phonic objects may be chosen randomly from the selected word. For example, returning to the “CAT” example, the first phonic object displayed may be an “A,” the second phonic object may be a “T,” and the third phonic object may be a “C.” It will be recognized that the phonic objects may appear in any predetermined or randomly selected order without departing from the scope of the appended claims.

In some embodiments, in accordance with the phonic learning method 700, the step of generating a word may be omitted and instead a phonic object may be selected randomly from a predetermined phonic object set. In some embodiments, phonic object sets may comprise, for example, alphabets or abjads (alphabets with consonants only) such as the Latin, Greek, Arabic, Syriac, Cyrillic, or Hebrew alphabet which may be used to generate appropriate phonic objects. In other embodiments, the phonic object set may be a subset of an alphabet, such as, for example, vowels or consonants.

In some embodiments, in accordance with the phonic learning method 700, one or more than one additional phonic object may be selected 706 from the phonic object set. In some embodiments, the one or more additional phonic objects may be selected from a set of phonic objects excluding the phonic objects used in the selected word. For example, when the phonic learning method 700 selected the word “CAT,” the one or more additional phonic objects may be selected from the phonic object set of the Latin alphabet, excluding the phonic objects “C,” “A,” and “T.”

After selecting the phonic object from the word and, in some embodiments, the one or more additional phonic objects, in accordance with the phonic learning method 700, the selected phonic object, and the one or more additional phonic objects, may be displayed 706 on the display screen of the visual peripheral output device 202. In one embodiment, the phonic objects are displayed inside of graphical objects on the display screen, such as, for example, a bubble. In other embodiments, the phonic objects may be displayed contained in a first graphical object, such as a balloon and, after selection, displayed within a second graphical object, such as a bubble.

In some embodiments, the electronic device 100 may generate an audible signal representative of the phoneme of the selected phonic object. Generating the audible signal may occur, in various embodiments, just prior to, simultaneously with, or a short time after, initially displaying the phonic object to the user. In addition, generating the audible signal may occur whenever the phonic object interacts with the edge of the display screen or one or more than one interaction object. For example, the software program may generate an interaction object in the form of a horizontal bar near the bottom of the display. Interaction between the phonic object and the interaction object would result in the electronic device 100 generating an audible signal representative of the phoneme of the phonic object.

Once the user has selected a phonic object, the position of the phonic object may be affected 710 by the user using any suitable input, including the motion sensor 204 of electronic device 100. Selection 708 of a phonic object can be performed using any suitable input option, including the touch screen of the electronic device 100 or a pointer device, such as an electronic mouse, connected to electronic device 100. Once the phonic object has been selected 708, the user may affect 710 the location of the phonic object on the screen, for example, through inputs from the motion sensor 204. A user may manipulate the electronic device 100 such that the motion sensor 204 records the change in orientation of the electronic device 100. This change in orientation of the electronic device 100 results in the motion sensor 204 generating electronic signals representative of the change in orientation, which are interpreted by the processor subsystem 102 and results in movement 710 of the phonic object on the display screen in relation to the change in orientation of electronic device 100. For example, in one embodiment, tilting electronic device 100 to the left of a central axis would result in the phonic object moving to the left side of the display screen. In another embodiment, tilting the electronic device 100 to the left would result in imparting some acceleration to the phonic object such that the phonic object may continue to move in its original direction (for example towards the right side of the display screen) until the acceleration applied due to the tilting of the electronic device 100 is great enough to affect the trajectory of the phonic object on the display screen.

As the phonic object is moved around the display screen of the visual peripheral output device 202, either as a result of interactions with the environment or based on inputs from the motion sensor 204 or other inputs, the phonic object may interact 712 with the edge of the display screen or one or more interaction objects. When the phonic object interacts 712 with either the edge of the display screen or an interaction object, the electronic device 100 generates 714 an audible signal representative of the phoneme of the phonic object. By generating 714 the audible signal representative of the phoneme sound of the phonic object when the phonic object interacts with the edge of the screen or an interaction object, the relationship between the phonic object and the phoneme sound may be reinforced to a user of the device.

In one embodiment, the environment generated on the display may contain one or more containers into which the user can direct the phonic object. The one or more containers may correspond to the correct location of the phonic object within the selected word. For example, when the selected word is “BAT” and the currently display phonic object is an “A,” then the second container (or middle container) would be the container correctly corresponding to the location of the “A” within the word “BAT.” In one embodiment, the user may use the motion sensor 204 inputs to steer 710 the phonic object such that it falls 716 into the container representing the correct location of the phonic object within the word. In another embodiment, the display may contain only one container, which is used to collect all of the phonic objects in the selected word. In this embodiment, as the phonic objects fall into the container, the phonic objects may appear 718 on the display in a predetermined location and in the order in which they appear in the selected word.

The phonic learning method 700 may then check 720 to see whether every phonic object of the selected word has been displayed to the user. When phonic objects remain which have not been displayed to the user (including phonic objects that appear multiple times within the same word), the phonic learning method 700 may loop back and select 704 another phonic object from the word, excluding each of the phonic objects that have already been displayed to the user. The phonic learning method 700 may choose the phonic objects either at random or according to a predetermined pattern such as, for example, displaying the phonic objects in the order in which they appear in the correctly spelled word. The phonic learning method 700 may continue to loop until all of the phonic objects that appear within the selected word have been displayed to the user.

In some embodiments, once all of the phonic objects associated with the selected word have been displayed to the user, the phonic learning method 700 may generate 722 an audible signal representative of the pronunciation of the selected word. In one embodiment, the audible signal may contain only the pronunciation of the selected word. In another embodiment, the audible signal also may comprise the phonemes of each of the phonic objects that make up the word, generated in order, followed by generating an audible signal representative of the selected word. It will be appreciated that the audible signal generated after all of the phonic objects have been identified may contain more or fewer sounds and still be within the scope of the appended claims. After each phonic object has been identified, the phonic learning method 700 may loop back and generate a new word.

With reference now to FIGS. 7-14, one embodiment of the display of an electronic device 100 executing the method for interactive learning 700 is discussed. In the embodiment of the phonic learning method 700 associated with FIGS. 7-14, the word “PAN” is selected as the word to be spelled. The selection of the word “PAN” is used merely as an illustration of the operation of the phonic learning method and is not intended to be limiting in anyway. One skilled in the art will appreciate that any word, in any language which uses discrete phonic objects, may be selected as the target word.

In some embodiments, in accordance with the phonic learning method 700, an image associated with the selected word may be displayed. In the embodiment associated with FIGS. 7-14, the selected word is “PAN” and therefore an image 810 of a pan is displayed in the lower left hand corner of a display screen 816. By displaying an image 810 associated with the word to spelled, the phonic learning method 700 can be used to teach a user to associate the spelling and pronunciation of a word (and its specific phonemes) with the item that the word describes.

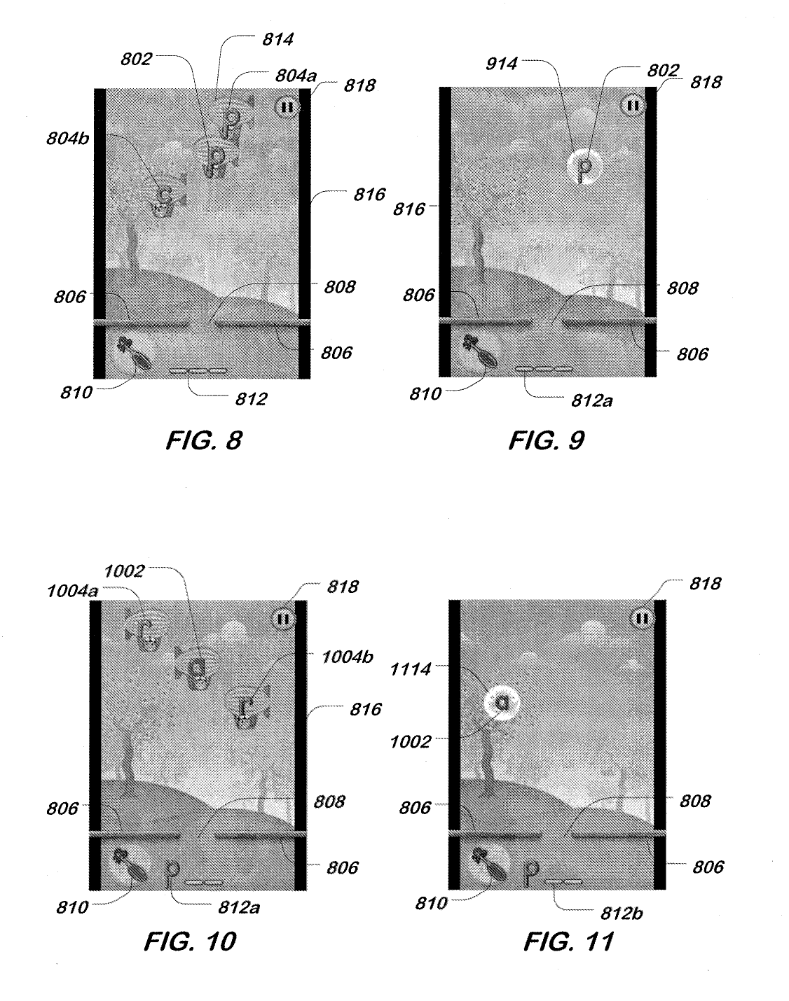

In the embodiment shown in FIG. 8, in accordance with the phonic learning method 700, a phonic object “P” is selected as the first letter 802 and is displayed on the display screen 816. Additional phonic objects 804a, 804b (the letters “P” and “C”), among others, are selected and displayed on the display screen 816 in conjunction with the first phonic object 802. As shown in the embodiment in FIG. 8, the additional phonic objects 804a, 804b may be chosen from a set including the phonic objects used to spell the selected word. In other embodiments, the phonic learning method 700 may exclude any phonic objects that are used to spell the selected word, for example, not displaying a second “P” when the word to be spelled is “PAN.”As shown in FIG. 8, the phonic objects 802, 804a, 804b may initially be displayed in a graphical container 814, such as a balloon dirigible (e.g., blimp, airship), for example.

Once the phonic objects have been displayed, a user may select one of the displayed phonic objects. As shown in FIG. 9, once a user selects one of the previously displayed phonic objects 802, 804a, 804b, the first selected phonic object 802 is displayed on the display screen 816 inside of a second graphical container, such as a bubble 914. In addition, once a user has selected one of the phonic objects, e.g., the first selected phonic object 802, the other phonic objects options, e.g., the unselected phonic objects 804a, 804b, are removed from the display screen 816. With reference now to FIGS. 6-10 a user may affect the position of the bubble 914 on the display screen 816 through various inputs, including the motion sensor 204. By moving the electronic device 100 (e.g., tilting the electronic device 100 about one or more than one axis) the user can impart direction and motion (or alternatively acceleration) to the bubble 914 thereby steering the bubble 914, which contains the first selected phonic object 802, around the display screen 816. As the bubble 914 is moved around the display screen, the bubble 914 may come into virtual contact with the edge of the display screen 816 or interaction objects, such as the horizontal bars 806 shown in FIGS. 8-14. When the bubble 914 interacts with the edge of the display screen 816 or the horizontal bars 806, the electronic device 100 may generate an audible signal representative of the phoneme of the first selected phonic object 802. It will be appreciated, that success is to be measured by actually guiding the bubble 914 through a container 808. Accordingly, when the bubble 914 interacts with the edge of the display screen 816 or the horizontal bars 806 rather than entering into the container 808, an audible signal representative of the phoneme of the first selected phonic object 802 may be generated to serve as positive reinforcement learning experience for the user and as a suggestion to keep trying until the bubble 914 is successfully guided into the container 808. For example, with reference to FIG. 9, when the bubble 914 containing the first selected phonic object 802 “P” interacts with the edge of the display screen 816, the electronic device would generate an audible signal representative of the phoneme /p/.

As discussed above, the user may affect the position of the bubble 914 on the display screen 816 through the motion sensor 204 of the electronic device 100. As discussed in connection with FIGS. 7-14, in accordance with the phonic learning method 700, one or more than one container 808 may be created on the display screen 816 into which the bubble 914 may be directed. As shown in FIG. 10, once the bubble 914 has been steered into the container 808, the first selected phonic object 802 may be displayed on the display screen 816 in a position corresponding to its placement in the selected word. For example, as shown in FIG. 10, the “P” has been previously directed into the container 808 and is now displayed along the bottom of the display screen in the first phonic object position 812a, corresponding to the location of the “P” in the word “PAN.” When the bubble 914 containing the first selected phonic object 802 is directed into the container 808 which does not correspond to the position of the first selected phonic object 802 in the selected word, or when the first selected phonic object 802 is a phonic object that does not appear in the selected word, the first selected phonic object 802 will not be placed in any of the phonic object positions 812a, 812b, 812c.

In some embodiments, the orientation, position, or size of the containers 808 may be affected by interaction with the bubble 914 containing the first selected phonic object 802. For example, the phonic learning method 700 may increase the size of the container 808 located between the horizontal bars 806 each time the bubble 914 containing the first selected phonic object 802 interacts with the horizontal bars 806. By increasing the size of the container 808, the phonic learning method 700 will increase the likelihood that a user can direct the bubble 914 into the container 808. In another example, where multiple containers are present, the size of the correct container may increase in size while the size of the incorrect containers may decrease in size. One skilled in the art will recognize that many variations exist with respect to altering the containers and are within the scope of the appended claims.

Once the bubble 914 has been successfully directed into the container 808, in accordance with the phonic learning method 700, a second phonic object 1002 is selected to be displayed on the display screen 816. As shown in FIG. 10, in accordance with the phonic learning method 700, a second phonic object 1002 of “PAN,” an “A,” is selected and displayed on the display screen 816. Additional random phonic objects 1004a, 1004b (the letters “R” and an “R”), among others, also are selected and displayed on the display screen 816 in conjunction with the second phonic object 1002.

As shown in FIG. 11, the user may select one of the displayed phonic objects, in this case the “A,” which is then displayed within a graphical object such as a bubble 1114, for example. Additionally, as discussed above, the non-selected phonic objects 1004a, 1004b (FIG. 10) have been removed from the display screen 816. The position of the bubble 1114 containing the second selected phonic object 1002 may be affected through the motion sensor 204 as discussed above. When the bubble 1114 interacts with either the edge of the display screen 816 or an interaction object, such as the horizontal bars 806, the electronic device 100 will generate an audible signal representative of the phoneme /a/ such that a user will associate the /a/ phoneme with the visual portion of the phonic object “A” shown on the display. As previously discussed, this may be used as form of positive reinforcement when the user fails to guide the selected phonic object through the container 808. The user may continue to attempt directing the bubble 1114 containing the selected phonic object 1002 into the container 808 using the motion sensor 204 or other suitable input.

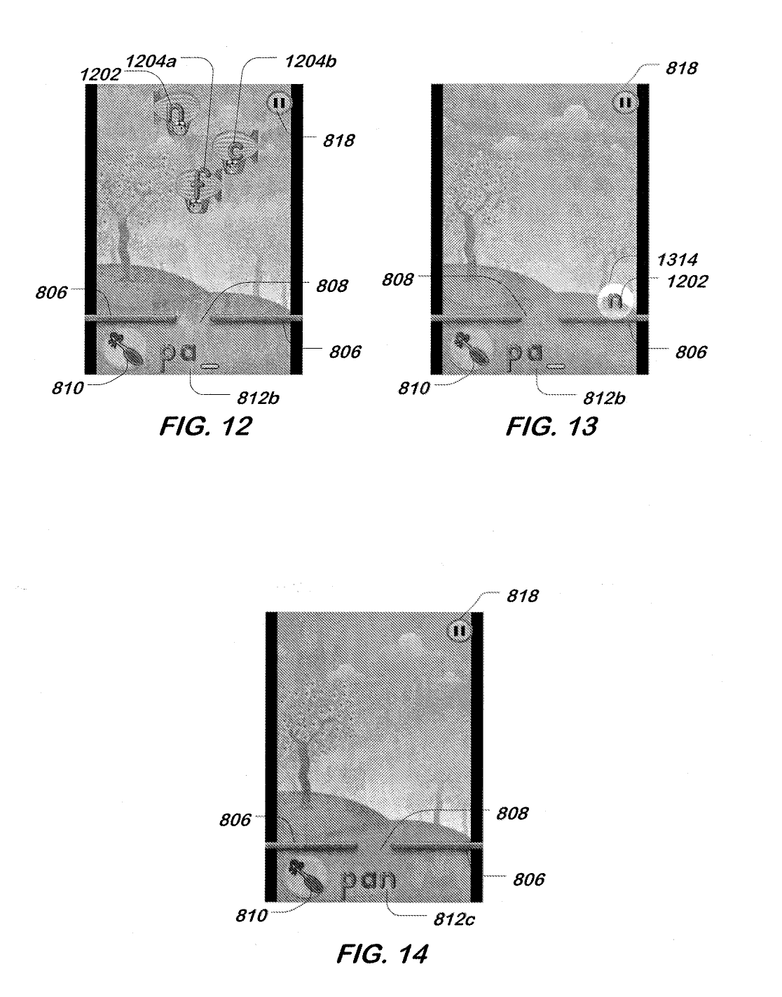

FIG. 12 illustrates the display of the phonic learning method 700 after the bubble 1114 has been successfully directed into the container 808. The “A” is now displayed next to the “P” in the second position 812b of the word “PAN.” In accordance with the phonic learning method 700, a third phonic object 1202, “N,” is selected and displayed on the display screen 816. Additional random phonic objects 1204a, 1204b (the letters “F” and “C”), among others, are selected and displayed on the display screen 816 in conjunction with the third phonic object 1202.

FIG. 13 illustrates an interaction between the bubble 1314 containing the third selected phonic object 1202, in this case an “N,” and an interaction object, the horizontal bar 806. As discussed above, when a bubble containing a phonic object interacts with an interaction object, the electronic device 100 generates an audible signal representative of the phoneme associated with the selected phonic object. In the example shown in FIG. 13, when the bubble 1314 containing the third selected phonic object 1202 interacts with the horizontal bar 806, an audible signal representative of the phoneme /n/ is generated by the electronic device 100. In addition, when the bubble 1314 containing the phonic object 1202 interacts with an interaction object, for example the horizontal bar 806, the interaction object imparts a new direction and movement (or a new acceleration) to the bubble 1314. For example, when the bubble 1314 interacts with the horizontal bar 806, the horizontal bar 806 causes the bubble to change directions and move away from the horizontal bar 806.

FIG. 14 illustrates the final screen displayed in accordance with the phonic learning method 700 for the selected word “PAN.” The third phonic object 1202 has been displayed in the third position 812c along the bottom of the display screen 816, completing the selected word. In some embodiments, when the selected word is completed, the electronic device 100 will generate an audible signal representative of the complete pronunciation of the selected word. For example, in FIG. 14, the electronic device 100 may generate an audible signal representative of the pronunciation of the word “PAN.” In other embodiments, the generated audible signal also may contain the pronunciation of each phoneme associated with the phonic objects 802, 1002, 1202 of the selected word. For example, the electronic device 100 may generate an audible signal representative of the /p/ phoneme, followed by the /a/ phoneme, followed by the /n/ phoneme. The audible signal also may be contain the complete pronunciation of the selected word.

Although in accordance with the phonic learning method 700 discussed with reference to FIGS. 7-14, the phonic objects 802, 1002, 1202 of the selected word were selected in the order in which they appear in the selected word, it will be appreciated by one skilled in the art that the present disclosure is not so limited. For example, in accordance with various embodiments of the phonic learning method 700, some phonic objects other than the first phonic object of the word may be selected to be presented first. For example, the phonic object “N” of “PAN” may be chosen as the first phonic object, the “P” as the second phonic object, and the “A” as the third phonic object, among other variations in the selection process.

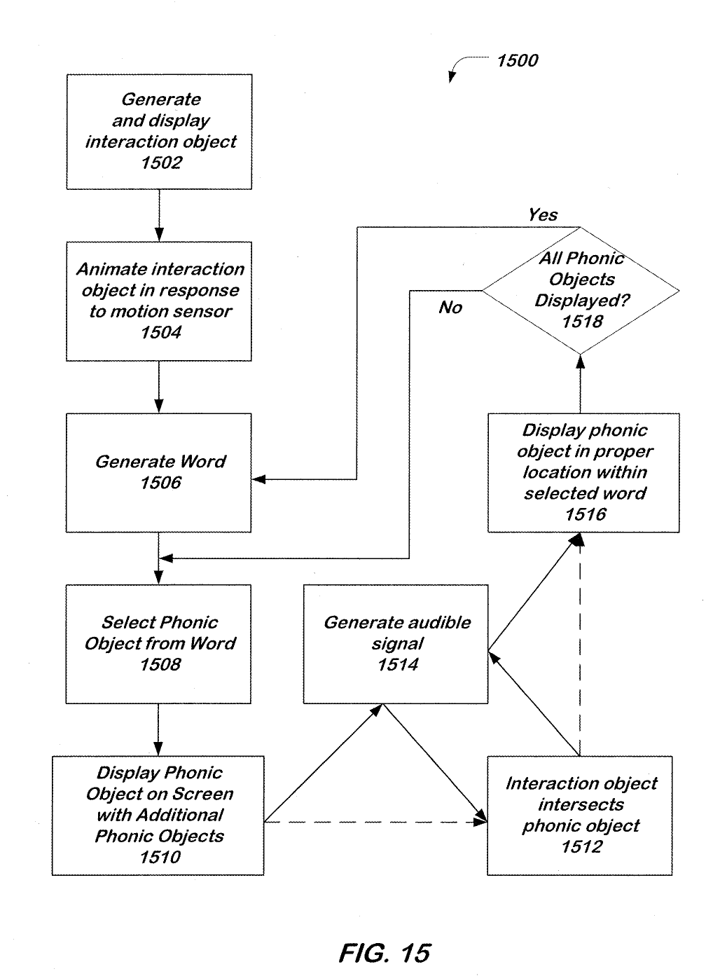

FIG. 15 shows a logic diagram of one embodiment of the phonic learning method 1500 which can be implemented on a mobile computing device, such as the electronic device 100 described in connection with FIGS. 1-4, for example. In one embodiment, a set of computer-executable instructions corresponding to the phonic learning method 1500 is loaded into the volatile memory of the electronic device 100. In accordance with the phonic learning method 1500, an interaction object is generated 1502 and the interaction object 1502 is displayed on the display screen of the electronic device. In one embodiment, the interaction object may be shown as an animated character such as, for example, an animated ant. The animated character may be shown performing an activity, such as, for example, snowboarding. The phonic learning method 1500 animates the interaction object, changing thee position of the interaction object on the display screen, in response to a signal from any suitable input, for example, the motion sensor 204. By moving the electronic device 100 the user can impart direction and motion (or alternatively acceleration) to the interaction object thereby steering the interaction object around the display screen.

In some embodiments, in accordance with the phonic learning method 1500, a word is generated 1506. In accordance with on embodiment of the phonic learning method 1500, a word may be randomly selected from a predefined list of words. In one embodiment, predefined lists of words may be generated comprising varying levels of difficulty such as, for example, grouping words containing fewer phonic objects or that are easily spelled as a lower level list and grouping words containing a large number of phonic objects or difficult spellings as a higher level list. In another embodiment, word lists may be generated by grouping words based on various grammatical or phonetic rules, such as, for example, list containing words with a “ph” or words that utilize the “i before e rule.” It will be appreciated that any grouping system may be used to create a predetermined set of word lists. All such systems and groupings are within the scope of the appended claims.

After the word is generated 1506, in accordance with one embodiment of the phonic learning method 1500, a phonic object may be selected 1508 from a set of phonic objects that comprise the selected word. In some embodiments, the phonic objects may be selected 1508 in sequential order based on their appearance in the selected word. For example, when the selected word is “CAT,” the first phonic object selected may be a “C,” the second letter may be an “A,” and the third letter may be a “T.” In other embodiments, the phonic objects may be selected 1508 randomly from the selected word. For example, using the “CAT” example from above, the first phonic object selected may be an “A,” the second phonic object selected may be a “T,” and the third phonic object selected may be a “C.” One skilled in the art will recognize that the phonic objects may appear in any predetermined or randomly selected order without departing from the scope of the appended claims.

In accordance with one embodiment of the phonic learning method 1500, the step of generating 1506 a word may be omitted and instead a phonic object may be chosen randomly from a predetermined phonic object set. In some embodiments, sets of phonic object may comprise, for example, alphabets or abjads (alphabets with consonants only) such as the Latin, Greek, Arabic, Syriac, Cyrillic, or Hebrew alphabet which may be used to generate appropriate phonic objects. In other embodiments, the phonic object set may be a subset of an alphabet, such as, for example, vowels or consonants.

In accordance with one embodiment of the phonic learning method 1500, an audible signal representative of the pronunciation of the selected word may be generated. In some embodiments, the audible signal is generated prior to displaying the selected phonic object on the display screen. By generating an audible signal representative of the selected word, a user will reinforce the association between the pronunciation of the word and the later identified phonic objects.

In some embodiments, in accordance with the phonic learning method 1500, one or more than one additional phonic object may be selected 1510 from the phonic object set. The one or more than one additional phonic object may be selected from a set of phonic objects excluding the phonic objects which appear in the selected word. For example, when the selected word is “CAT,” the one or more additional phonic objects may be selected from the phonic object set of the Latin alphabet, excluding the letter “C,” “A,” and “T.” In another embodiment, the phonic learning method 1500 may select the one or more additional phonic objects from the set of phonic objects which comprise the selected word. For example, when the word is “CAT,” the one or more additional phonic objects may be selected from the set of phonic objects consisting of the letters “C,” “A,” and “T.”

In accordance with one embodiment of the phonic learning method 1500, the selected phonic object may be displayed 1510 in conjunction with one or more than one additional phonic object on the display screen of the visual peripheral output device 202. In one embodiment, the phonic objects are displayed within graphical objects on the screen, such as, for example, bubbles.

In accordance with one embodiment of the phonic learning method 1500, an audible signal representative of the audible portion (comprising the phoneme sound) of the selected phonic object may be generated 1514. Generating 1514 the audible signal may occur, in various embodiments, shortly before, simultaneously with, or shortly after displaying the phonic object on the display screen. In other embodiments, the phonic learning method 1500 may generate an audible signal representative of the selected word. In addition, in accordance with the phonic learning method 1500 the audible signal may be generated 1514 whenever the interaction object intersects 1512 the phonic object on the display screen. This intersection may occur, for example, by affecting the position of the interaction object on the screen through the motion sensor 204 inputs.

Once the selected phonic object has been intersected 1512 by the interaction object, the selected phonic object may be displayed 1516 on the display screen in a location corresponding to its location within the selected word. When the interaction object virtually contacts one of the random phonic objects, the random phonic object will not be displayed on the display screen in a location corresponding it its location within the selected word, even when the random phonic object appears in the selected word.

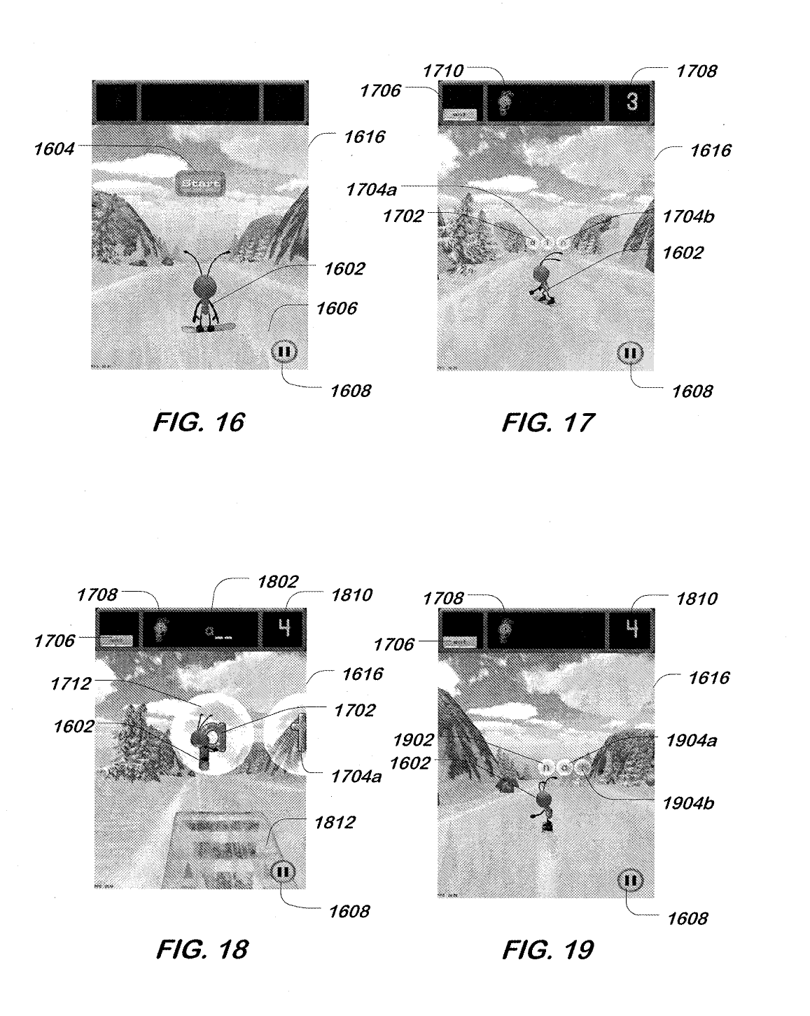

With reference now to FIGS. 16-22, one embodiment of the phonic learning method 1500 implemented by a mobile computing device, such as the electronic device 100 discussed in connection with FIGS. 1-4, is discussed. As shown in FIG. 16, the interaction object 1602 is shown as an animated ant riding a snowboard. A start button 1604 also is shown, which can be selected by a user to begin the phonic learning method 1500. As shown in FIG. 17, the start button 1604 has been selected and in accordance with the phonic learning method 1500, the word “ANT” has been selected. The selection of the word “ANT” is used merely as an illustration of the operation of the phonic learning method 1500, and is not intended to be limiting in anyway. One skilled in the art will appreciate that any word, in any language which uses phonic objects 1702 with an associated phoneme may be selected.

As shown in the embodiment associated with FIG. 18, the phonic learning method 1500 also may comprise generating several static objects 1812 which can affect the position of the interaction object 1602. For example, as shown in FIG. 18, the static objects 1812 may be generated in the form of ramps which cause the interaction object 1602 to change its position relative to some base position on a display screen 1616, such as the ground level 1606.

In some embodiments, in accordance with the phonic learning method 1500, an image 1710 associated with the selected word may be displayed. In the embodiment shown in FIGS. 16-22, the selected word is “ANT” and the corresponding image 1710 of an ant is displayed on the display screen 1616. By displaying an image 1710 associated with the selected word, the phonic learning method 1500 can teach a user to associate the phonic objects and pronunciation of a word with the item which the word describes.

In the embodiment associated with FIGS. 16-22, in accordance with the phonic learning method 1500, the phonic objects may be selected in the order in which they appear in the selected word. Therefore, a first selected phonic object 1702 has been selected as an “A,” the first letter of the selected word “ANT.” In addition, in accordance with the phonic learning method 1500, two additional phonic objects 1704a, 1704b may be selected from the set of phonic objects which comprise the selected word, e.g., from the set consisting of letters “A,” “N,” and “T” and displayed on the display screen 1616. The first selected phonic object 1702 and the two additional phonic objects 1704a, 1704b are displayed within graphical bubbles. In accordance with the phonic learning method 1500, an audible signal representative of the first selected letter, the /a/ phoneme, may be generated by the electronic device 100 to signal to the user which on of the displayed the phonic objects 1702, 1704a, 1704b the interaction object 1602 should be directed towards. As shown in FIG. 17, the interaction object 1602 is pointed towards the left side of the display screen. The orientation of the interaction object 1602 corresponds to the orientation of the electronic device 100. For example, the interaction object 1602 shown in FIG. 17 has a generally left-leaning orientation. This orientation corresponds to a user moving or orienting the electronic device 100 in a generally left direction. The movement of the electronic device 100 is converted by the motion sensor 204 and the processor subsystem 102 into a change in direction or acceleration of the interaction object 1602. In one embodiment, the display screen comprises a score 1708 representative of the number of correctly identified phonetic objects. The display screen may comprise a user interface button 1608 which allows a user to bring up a menu or otherwise interact with the device. In the embodiment associated d with FIGS. 15-22, the user interface button 1608 is a pause button.

Still with reference to FIGS. 15-22, a user may affect the position of the interaction object 1602 on the display screen 1616 by altering the orientation or acceleration of the electronic device 100. As shown in FIG. 18, the interaction object 1602 has been steered through input of the motion sensor 204 into a position where it will intersect the first selected phonetic object 1702 when it jumps the ramp, e.g., the static object 1812. When the interaction object 1602 intersects the first selected phonic object 1702, the electronic device 100 generates an audible signal representative of the phoneme /a/, the phoneme of the first selected phonic object 1702. In addition, the phonic learning method 1500 has displayed the first selected phonic object 1702 in the first position, corresponding to its location in the selected word, “ANT.” In one embodiment, in accordance with the phonetic learning method 1500, the previous score 1708 (FIG. 17) is advanced by one for each correctly identified phonetic object, resulting in new score 1810.

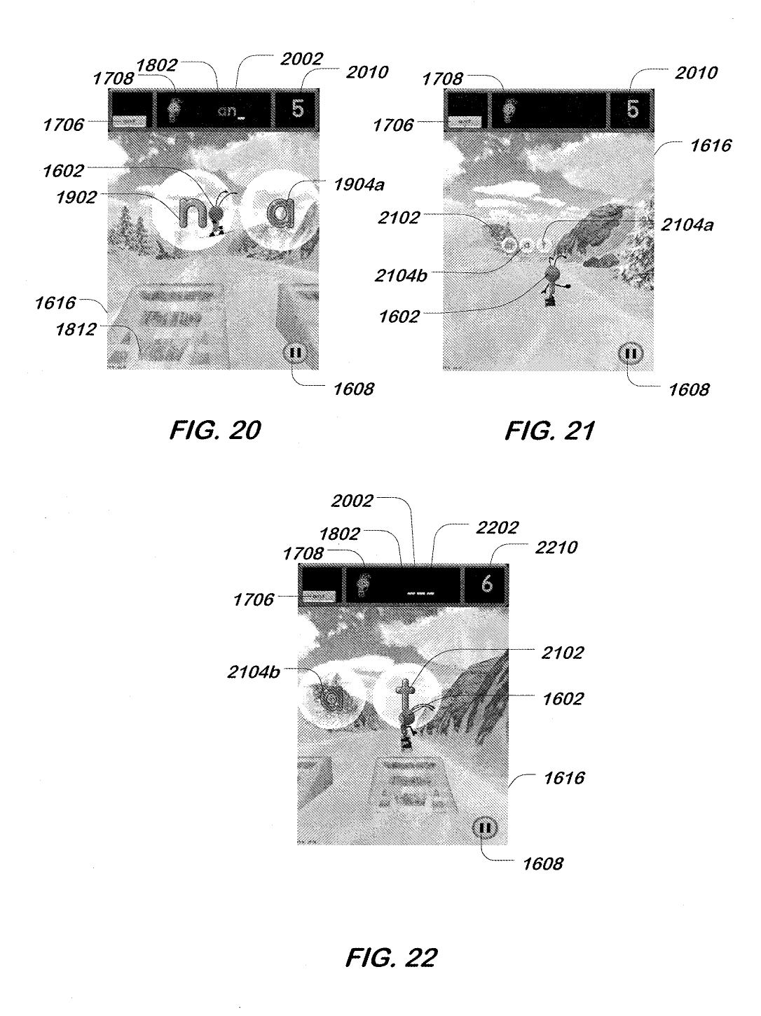

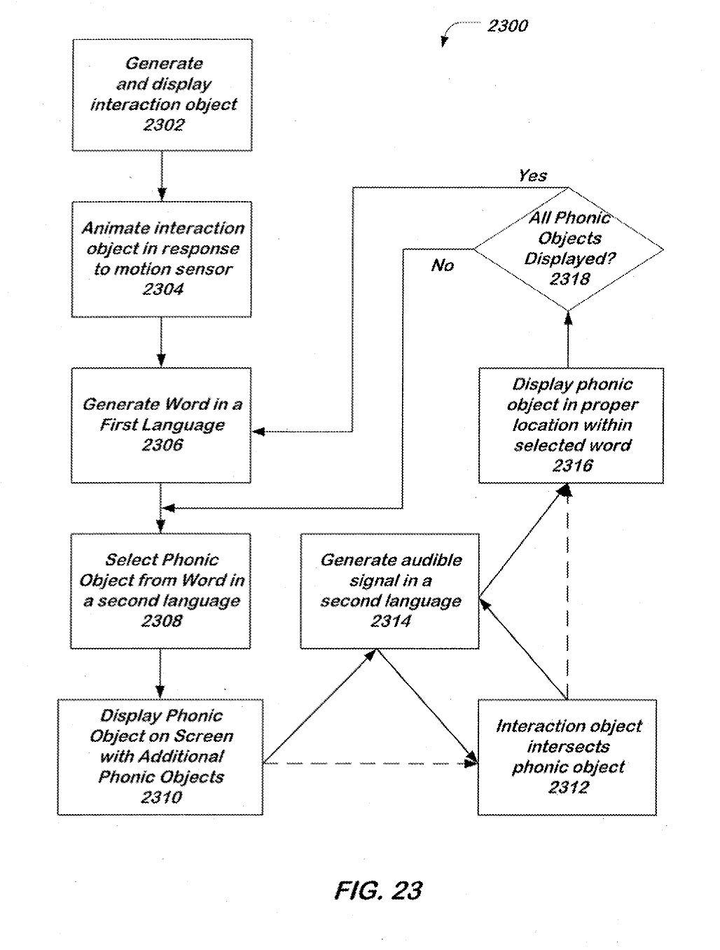

As shown in FIG. 19, in accordance with the phonetic learning method 1500, a second phonetic object 1902 is selected and displayed on the display screen 1616. In accordance with the phonetic learning method 1500, also selected and displayed in conjunction with the second phonetic object 1902 are two additional selected phonetic objects 1904a, 1904b. As previously discussed, the additional phonetic objects 1904a, 1904b may be selected from a set of phonetic objects which comprise the selected word or may be randomly selected from other sets of phonetic objects. FIG. 20 shows the interaction object 1602 interacting with the second additional phonetic object 1902. As previously discussed, the interaction between the interaction object 1602 and the second phonetic object 1902 causes the electronic device 100 to generate an audible signal representative of the /n/ phoneme. In addition, the second phonetic object 1902 is displayed in the second position 2002 corresponding to the second position of the phonetic object 1902 within the selected word. The score 2010 is advanced by one to indicate that another phonetic object has been correctly identified.

FIG. 21 shows a screen shot of the final letter being presented from the selected word. The third phonetic object 2102 is selected as “T,” the only phonetic object from the word “ANT” that has not yet been presented to the user. As previously discussed, two additional phonetic objects 2104a, 2104b are selected and displayed on the display screen 1616 in conjunction with the third phonetic object 2102. The location interaction object 1602 may be altered by the user through the motion sensor 204 inputs such that the interaction object 1602 will intersect the third phonetic object 2102 after jumping the ramp, e.g., the static interaction object 1812. FIG. 22 shows the interaction object 1602 virtually contacting the third phonetic object 2102. Contact between the interaction object 1602 and the third phonetic object 2102 results in the electronic device 100 generating an audible signal representative of the /t/ phoneme. In addition, the third phonetic object 2102 may be displayed in the third position 2202 corresponding to the third phonetic object's 2102 position in the selected word. In the embodiment shown in FIG. 22, the first position 1802, second position 2002, and third position 2202 are now shown without phonetic objects, indicating that word “ANT” has been selected again.

In some embodiments, in accordance with the phonic learning method 1500, an audible signal representative of the selected word may be generated prior to displaying the first selected phonic object (and the one or more additional phonic objects). In such embodiment, the user may direct the interaction object 1602 through the selected phonic objects 1802, 1102, 2102 in the order in which they appear in the selected word, without additional suggestions or direction from the phonic learning method 1500. For example, when the selected word is “ANT,” the user may be expected to guide the interaction object into contact with the a first phonic object, in this case the “A,” followed by a second phonic object, “N,” and finally a third phonic object, “T,” without an audible signal representation of the specific phonic objects to be intersected. In one embodiment, the electronic device 100 may generate a signal representative of the phoneme of the intersected phonic object. In such embodiment, the phonic learning method 1500 teaches a user the proper spelling of a word and pronunciation, but without directly identifying the phonic objects that make up the word prior to the user interacting with those phonic objects.

The phonic learning method 700, 1500 described herein in connection with FIGS. 7-22, may be adapted into a phonic learning method for learning a foreign language using the electronic device 100 discussed in connection with FIGS. 1-4. In accordance with one embodiment of a foreign language learning method 2300, shown in FIG. 22, a set of computer-executable instructions is loaded into the volatile memory of the electronic device 100. In accordance with the foreign language learning method 2300 an interaction object is generated and displayed on the display screen 2302. In one embodiment, the interaction object may be shown as an animated character such as, for example, an animated ant. The animated character may be shown performing an activity, such as, for example, snowboarding. The foreign language phonic learning method 2300 animates the interaction object 2304, changing the position of the interaction object on the display screen in response to a signal from any suitable input, for example, the motion sensor 204. By moving the electronic device 100 the user can impart direction and motion (or alternatively acceleration) to the interaction object thereby steering the interaction object around the display screen.

In some embodiments, in accordance with the foreign language phonic learning method 2300, a word is initially generated in a first language 2306. A word from a predefined list of words in the first language may be randomly selected. In one embodiment, predefined lists of words may be generated comprising varying levels of difficulty such as, for example, words referring to simple objects or words which are similar to the words in a second language, such as a user's native language. It will be appreciated that any grouping system may be used to create a predetermined set of word lists. All such systems and groupings are within the scope of the appended claims.

In one embodiment, in accordance with the foreign language phonic learning method 2300, an audible signal representative of the word in a first language is generated and the corresponding phonic objects associated with are generated in a second language. For example, in one embodiment, when the selected word is “CAT,” the foreign language phonic learning method may generate an audible signal representative of the word CAT in a first language, for example, Spanish. The audible signal would be representative of the Spanish word “gato” which translates into “cat” in English. In accordance with the foreign language phonic learning method 2300, one or more than one phonic object is selected from the word in a second language 2308, for example, English. In accordance with the foreign language phonic learning method 2300, one or more than one phonic object may be displayed sequentially 2310 in the order in which they appear in the word in the second language. By interacting with the phonic objects in the order in which they appear in the word in a second language, a native speaker of the first language will learn to spell and associate the word in the second language with the word in the first language. For example, a native Spanish speaker using a mobile computing device implementing the foreign language phonic learning method 2300 will be able to use the method to learn that the English word “cat” is the equivalent of the known word “gato.” In addition, the user may learn the spelling and the pronunciation of the word.

In some embodiments, in accordance with the foreign language phonic learning method 2300, one or more than one additional phonic object may be selected from the phonic object set of the second language. The one or more additional phonic objects may be selected from a set of phonic objects excluding the phonic objects which appear in the selected word. For example, when the selected word is “CAT,” the one or more additional phonic objects may be selected from the phonic object set of the Latin alphabet, excluding the letter “C,” “A,” and “T.” In another embodiment, in accordance with the foreign language phonic learning method 2300, one or more than one additional phonic object may be selected from the set of phonic objects which comprise the selected word. For example, when the word “CAT” is selected, the one or more additional phonic objects may be selected from the set of phonic objects consisting of the letters “C,” “A,” and “T.”

In accordance with various embodiments of the foreign language phonic learning method 2300, the selected phonic object and one or more additional phonic objects may be displayed 2310 on the display screen of the visual peripheral output device 202. In one embodiment, the phonic objects are displayed within graphical objects on the screen, such as, for example, bubbles.

In accordance with various embodiments of the phonic learning method 2300, an audible signal representative of the audible portion (comprising the phoneme sound) of the selected phonic object may be generated in the second language 2314. Generating the audible signal may occur, in various embodiments, shortly before, simultaneously with, or shortly after displaying the phonic object on the display screen. In addition, in accordance with embodiment of the foreign language phonic learning method, the audible signal may be generated 2314 whenever the interaction object intersects the phonic object on the display screen 2312. This intersection may occur, for example, by affecting the position of the interaction object on the screen through the motion sensor 204 inputs.

Once the selected phonic object has been intersected by the interaction object 2312, the selected phonic object may be displayed on the display screen in a location corresponding to its location within the selected word. When the interaction object virtually contacts one of the random phonic objects, the random phonic object will not be displayed on the display screen in a location corresponding it its location within the selected word, even when the random phonic object appears in the selected word.

The foreign language phonic learning method 2300 may then check 2318 to see if all of the phonic objects of the word in the second language have been displayed to the user. If all of the phonic objects of the word in the second language have not been displayed to the user, the foreign language phonic learning method 2300 selects a new phonic object from the word in the second language to display to the user. If all of the phonic objects of the word in a second language have been displayed to the user, the foreign language phonic learning method 2300 may generate a new word in the first language.

In one embodiment, an article of manufacture is disclosed comprising a machine-accessible medium having instructions encoded thereon for enabling a processor to perform the operations of a method for phonic learning. The instructions enable the processor to perform the operations of generating at least a first phonic object comprising a visual portion and an audible portion, wherein the at least first phonic object is selected from a first group of phonic objects, wherein the audible portion comprises a phoneme associated with the at least first phonic object. The instructions further include displaying, on a visual peripheral output device, at least one interaction object and positioning by a user, the visual portion of the at least first phonic object on the visual peripheral output device by a corresponding movement of the mobile computing device, wherein the movement of the mobile computing device is correlated with a desired movement of the visual portion of the at least first phonic object, wherein the user is challenged to move the visual portion of the at least first phonic object towards a predetermined target position on the visual peripheral output device. The instructions further enable the audio peripheral output device to generate a first audible signal in response to an interaction between the at least one interaction object and the at least first phonic object, wherein the first audible signal audibly indicates whether the user correctly selected the phonic object that correspond to the word.

In one embodiment, the article of manufacture may further comprise instructions which enable the processor to generate at least a second phonic object comprising a visual portion and an audible portion. The at least second phonic object may be selected from a second group of phonic objects and the audible portion may be a phoneme associated with the at least second phonic object. The second phonic object may be displayed on the visual peripheral output device. In one embodiment, the first group of phonic objects comprises a group of phonic objects associated with a word. The word may be generated by a processor or generated by any other suitable means. In one embodiment, a second audible signal representative of the word may be generated by the audio peripheral output device. The first audible signal may be the audible portion of the at least first phonic object and may audibly indicates that the user has correctly selected the phonic object that corresponds to the word. In another embodiment, the first audible signal may audibly indicate that the user has incorrectly selected the phonic object that corresponds to the word. The second audible signal may be generated prior to displaying the phonic object on the visual peripheral output device.

In one embodiment, the instructions included on the machine-readable medium may further comprise instructions for displaying, on the visual peripheral output device, at least one correctly identified phonic object, wherein the at least one correctly identified phonic object is displayed in a position corresponding to the position in the word of at least one correctly identified phonic object. In one embodiment, the processor may generate the second audible signal when all of the first group of phonic objects have been displayed on the visual peripheral output device. The instructions may further enable the processor to display an image representative of the word on the visual peripheral output device. In one embodiment, the at least one first and second phonic objects may be displayed within two or more graphical containers.

In one embodiment, an article of manufacture is disclosed comprising a machine-accessible medium having instructions encoded thereon for enabling a processor to perform the operations of generating, at least a first phonic object comprising a visual portion and an audible portion. The at least first phonic object may be selected from a first group of phonic objects and the audible portion may comprises a phoneme associated with the at least first phonic object. The instructions further enable the processor to generate at least a second phonic object comprising a visual portion and an audible portion. The at least second phonic object is selected from a second group of phonic objects and the audible portion is a phoneme associated with the at least second phonic object. The visual peripheral output device may display the visual portions of the at least first and second phonic objects. At least one interaction object may be positioned by a user on the visual peripheral output device by a corresponding movement of the mobile computing device. The movement of the mobile computing device is correlated with a desired movement of the at least one interaction object and the user is challenged to move the at least one interaction object towards a predetermined target position on the visual peripheral output device. The interaction object may be displayed as, for example, an animated character on a snowboard. The position of the at least one interaction object on the visual peripheral output device is altered by the processor in response to the corresponding movement of the mobile computing device. The audio peripheral output device may generate a first audible signal in response to an interaction between the interaction object and the at least first phonic object, wherein the first audible signal audibly indicates whether the user correctly selected the phonic object that correspond to the word.

In one embodiment of the article of manufacture, the audio peripheral output device may generate a second audible signal representative of a word in a first language which comprises at least one phonic object. In one embodiment, the first group of phonic objects consists of a group of phonic objects associated with the word in a second language. In another embodiment, the second group of phonic objects consists of a group of phonic objects not associated with the word in the second language. In some embodiments the first language and the second language may be different languages. In one embodiment the first audible signal is the audible portion of the at least first phonic object. The first audible signal may audibly indicate that the user has correctly selected the phonic object that corresponds to the word. In another embodiment, the first audible signal may audibly indicate that the user has incorrectly selected the phonic object that corresponds to the word.

In one embodiment of the article of manufacture, the instructions may further comprise generating at least one static interaction object. In another embodiment, the second audible signal may be generated prior to displaying the at least first phonic object on the visual peripheral output device. The instructions may cause the visual peripheral output device to display at least one correctly identified phonic object, wherein the at least one correctly identified phonic object is displayed in a position corresponding to the position in the word of at least one correctly identified phonic object. The first audible signal may be generated when one or more target phonic objects have been displayed on the visual peripheral output device. In some embodiments, an image representative of the word may be displayed. In another embodiments, the at least one first and second phonic objects may be displayed within graphical containers.

Although the phonic learning method has been presented with reference to certain embodiments, one skilled in the art will recognize that the phonic learning method is not so limited. The phonic learning method may be implemented in any form of educational game capable of implementing the phonic learning method. The phonic learning method may be implemented, for example, as any one of a first-person shooter (FPS), a Side-scrolling shooter, a Pinball style game, a Paddle-style game (including Pong-style), a Target shooting game, a role-playing game (RPG), an action game including platform games, an Action-adventure game including stealth or survival horror games, Adventure games including puzzle, riddle, or interactive movie style games, a Simulation game including vehicle simulators, flight simulators, racing simulators, or combat simulators, or a Strategy game including real-time strategy (RTS) style or turn-based strategy (TBS) style games. The phonic learning method also may be implemented as a music-style game, Party game, Sports game, or Trivia game.

The functions of the various functional elements, logical blocks, modules, and circuits elements described in connection with the embodiments disclosed herein may be implemented in the general context of computer executable instructions, such as software, control modules, logic, and/or logic modules executed by the processing unit. Generally, software, control modules, logic, and/or logic modules comprise any software element arranged to perform particular operations. Software, control modules, logic, and/or logic modules can comprise routines, programs, objects, components, data structures and the like that perform particular tasks or implement particular abstract data types. An implementation of the software, control modules, logic, and/or logic modules and techniques may be stored on and/or transmitted across some form of computer-readable media. In this regard, computer-readable media can be any available medium or media useable to store information and accessible by a computing device. Some embodiments also may be practiced in distributed computing environments where operations are performed by one or more remote processing devices that are linked through a communications network. In a distributed computing environment, software, control modules, logic, and/or logic modules may be located in both local and remote computer storage media including memory storage devices.

Additionally, it is to be appreciated that the embodiments described herein illustrate example implementations, and that the functional elements, logical blocks, modules, and circuits elements may be implemented in various other ways which are consistent with the described embodiments. Furthermore, the operations performed by such functional elements, logical blocks, modules, and circuits elements may be combined and/or separated for a given implementation and may be performed by a greater number or fewer number of components or modules. As will be apparent to those of skill in the art upon reading the present disclosure, each of the individual embodiments described and illustrated herein has discrete components and features which may be readily separated from or combined with the features of any of the other several aspects without departing from the scope of the present disclosure. Any recited method can be carried out in the order of events recited or in any other order which is logically possible.

It is worthy to note that any reference to “one embodiment” or “an embodiment” means that a particular feature, structure, or characteristic described in connection with the embodiment is comprised in at least one embodiment. The appearances of the phrase “in one embodiment” or “in one aspect” in the specification are not necessarily all referring to the same embodiment.

Unless specifically stated otherwise, it may be appreciated that terms such as “processing,” “computing,” “calculating,” “determining,” or the like, refer to the action and/or processes of a computer or computing system, or similar electronic computing device, such as a general purpose processor, a DSP, ASIC, FPGA or other programmable logic device, discrete gate or transistor logic, discrete hardware components, or any combination thereof designed to perform the functions described herein that manipulates and/or transforms data represented as physical quantities (e.g., electronic) within registers and/or memories into other data similarly represented as physical quantities within the memories, registers or other such information storage, transmission or display devices.

It is worthy to note that some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, also may mean that two or more elements are not in direct contact with each other, but yet still co-operate or interact with each other. With respect to software elements, for example, the term “coupled” may refer to interfaces, message interfaces, application program interface (API), exchanging messages, and so forth.

It will be appreciated that those skilled in the art will be able to devise various arrangements which, although not explicitly described or shown herein, embody the principles of the present disclosure and are comprised within the scope thereof. Furthermore, all examples and conditional language recited herein are principally intended to aid the reader in understanding the principles described in the present disclosure and the concepts contributed to furthering the art, and are to be construed as being without limitation to such specifically recited examples and conditions. Moreover, all statements herein reciting principles, aspects, and embodiments as well as specific examples thereof, are intended to encompass both structural and functional equivalents thereof. Additionally, it is intended that such equivalents comprise both currently known equivalents and equivalents developed in the future, i.e., any elements developed that perform the same function, regardless of structure. The scope of the present disclosure, therefore, is not intended to be limited to the exemplary aspects and aspects shown and described herein. Rather, the scope of present disclosure is embodied by the appended claims.

The terms “a” and “an” and “the” and similar referents used in the context of the present disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as when it were individually recited herein. All methods described herein can be performed in any suitable order unless otherwise indicated herein or otherwise clearly contradicted by context. The use of any and all examples, or exemplary language (e.g., “such as,” “in the case,” “by way of example”) provided herein is intended merely to better illuminate the disclosed embodiments and does not pose a limitation on the scope otherwise claimed. No language in the specification should be construed as indicating any non-claimed element essential to the practice of the claimed subject matter. It is further noted that the claims may be drafted to exclude any optional element. As such, this statement is intended to serve as antecedent basis for use of such exclusive terminology as solely, only and the like in connection with the recitation of claim elements, or use of a negative limitation.

Groupings of alternative elements or embodiments disclosed herein are not to be construed as limitations. Each group member may be referred to and claimed individually or in any combination with other members of the group or other elements found herein. It is anticipated that one or more members of a group may be comprised in, or deleted from, a group for reasons of convenience and/or patentability.

While certain features of the embodiments have been illustrated as described above, many modifications, substitutions, changes and equivalents will now occur to those skilled in the art. It is therefore to be understood that the appended claims are intended to cover all such modifications and changes as fall within the scope of the disclosed embodiments.

What is claimed is:

1. A computer-implemented method for interactive learning on a mobile computing device, the method comprising:
generating, by a processor, at least a first phonic object comprising a visual portion and an audible portion, wherein the at least first phonic object is selected from a first group of phonic objects, wherein the audible portion comprises a phoneme associated with the at least first phonic object;
generating, by the processor, at least a second phonic object comprising a visual portion and an audible portion, wherein the at least second phonic object is selected from a second group of phonic objects, wherein the audible portion is a phoneme associated with the at least second phonic object;
displaying, on a visual peripheral output device, the visual portions of the at least first and second phonic objects;
positioning, by a user, at least one interaction object on the visual peripheral output device by a corresponding movement of the mobile computing device, wherein the movement of the mobile computing device is correlated with a desired movement of the at least one interaction object, wherein the user is challenged to move the at least one interaction object towards a predetermined target position on the visual peripheral output device;
altering, by the processor, a position of the at least one interaction object on the visual peripheral output device in response to the corresponding movement of the mobile computing device; and
generating, by the audio peripheral output device, a first audible signal in response to an interaction between the interaction object and the at least first phonic object, wherein the first audible signal audibly indicates whether the user correctly selected the phonic object that correspond to the word.

2. The computer-implemented method of claim 1, comprising generating, by an audio peripheral output device, a second audible signal representative of a word in a first language, wherein the word comprises at least one phonic object;

3. The computer-implemented method of claim 2, wherein the first group of phonic objects consists of a group of phonic objects associated with the word in a second language.

4. The computer-implemented method of claim 3, wherein the second group of phonic objects consists of a group of phonic objects not associated with the word in the second language.

5. The computer-implemented method claim 3, wherein the first language and the second language are different.

6. The computer-implemented method of any claim 1, wherein the first audible signal is the audible portion of the at least first phonic object.

7. The computer-implemented method of claim 1, wherein the first audible signal audibly indicates that the user correctly selected the phonic object that corresponds to the word.

8. The computer-implemented method of any of claim 1, wherein the first audible signal audibly indicates that the user has incorrectly selected the phonic object that corresponds to the word.

9. The computer-implemented method of claim 1 comprising generating at least one static interaction object.

10. The computer-implemented method of claim 1, wherein the second audible signal is generated prior to displaying the at least first phonic object on the visual peripheral output device.

11. The computer-implemented method of claim 1, comprising displaying, on the visual peripheral output device, at least one correctly identified phonic object, wherein the at least one correctly identified phonic object is displayed in a position corresponding to the position in the word of at least one correctly identified phonic object.

12. The computer-implemented method of claim 1, comprising generating, by the processor, the first audible signal when one or more target phonic objects have been displayed on the visual peripheral output device.

13. The computer-implemented method of claim 1, comprising displaying, on the visual peripheral output device, an image representative of the word.

14. The computer-implemented method of claim 1, wherein the at least first phonic object and the at least second phonic object are displayed within two or more graphical containers.

15. The computer-implemented method of claim 1, wherein the interaction object is displayed as an animated character on a snowboard.

16. A computer-implemented method for interactive learning on a mobile computing device, the method comprising:
generating, by a processor, at least a first phonic object comprising a visual portion and an audible portion, wherein the at least first phonic object is selected from a first group of phonic objects, wherein the audible portion comprises a phoneme associated with the at least first phonic object;
displaying, on a visual peripheral output device, at least one interaction object;
positioning, by a user, the visual portion of the at least first phonic object on the visual peripheral output device by a corresponding movement of the mobile computing device, wherein the movement of the mobile computing device is correlated with a desired movement of the visual portion of the at least first phonic object, wherein the user is challenged to move the visual portion of the at least first phonic object towards a predetermined target position on the visual peripheral output device; and
generating, by the audio peripheral output device, a first audible signal in response to an interaction between the at least one interaction object and the at least first phonic object, wherein the first audible signal audibly indicates whether the user correctly selected the phonic object that correspond to the word.

17. The computer-implemented method of claim 16, comprising:
generating, by the processor, at least a second phonic object comprising a visual portion and an audible portion, wherein the at least second phonic object is selected from a second group of phonic objects, wherein the audible portion is a phoneme associated with the at least second phonic object; and
displaying, on the visual peripheral output device, the at least second phonic object.

18. The computer-implemented method of claim 16, wherein the first group of phonic objects is a group of phonic objects associated with a word.

19. The computer implemented method of claim 18, comprising generating, by a processor, the word.

20. The computer implemented method of claim 18, comprising generating, by the audio peripheral device, a second audible signal representative of the word.

21. The computer-implemented method of claim 20, wherein the second audible signal is generated prior to displaying the phonic object on the visual peripheral output device.

22. The computer-implemented method of claim 16, wherein the first audible signal is the audible portion of the at least first phonic object.

23. The computer-implemented method of claim 16, wherein the first audible signal audibly indicates that the user correctly selected the phonic object that corresponds to the word.

24. The computer-implemented method of claim 16, wherein the first audible signal audibly indicates that the user incorrectly selected the phonic object that corresponds to the word.

25. The computer-implemented method of claim 16, comprising displaying, on the visual peripheral output device, at least one correctly identified phonic object, wherein the at least one correctly identified phonic object is displayed in a position corresponding to the position in the word of at least one correctly identified phonic object.

26. The computer-implemented method of any of claims 18, comprising generating, by the processor, the second audible signal when all of the first group of phonic objects have been displayed on the visual peripheral output device.

27. The computer-implemented method of claim 16, comprising displaying, on the visual peripheral output device, an image representative of the word.

28. The computer-implemented method of claim 16, wherein the at least first phonic object and the at least second phonic object are displaying within two or more graphical containers.

29. A system for interactive learning comprising:
a mobile device comprising:
a processor;
a motion sensor;
a memory subsystem;
a visual peripheral output device; and
an audio peripheral output device;
wherein the memory subsystem is encoded with instructions for enabling the mobile device to perform the steps of the computer-implemented method for interactive learning of claim 1.

30. A system for interactive learning comprising:
a mobile device comprising:
a processor;
a motion sensor;
a memory subsystem
a visual peripheral output device; and
an audio peripheral output device;
wherein the memory subsystem is encoded with instructions for enabling the mobile device to perform the steps of the computer-implemented method for interactive learning of claim 16.
